(19) United States
(12) Patent Application Publication
(10) Pub. No.: US 2009/0271497 A1
(43) Pub. Date: Oct. 29, 2009

(54) Affiliate Program Redirection System

(76) Inventor: Lee Roberts, Noble, OK (US)

Correspondence Address: ADVANTIA LAW GROUP, 9035 SOUTH 1300 EAST, SUITE 200, SANDY, UT, 84094, US

(21) Appl. No.: 12/111,785

(22) Filed: Apr. 29, 2008

(51) Int. Cl. G06F 3/00

(52) U.S. Cl. 709/218

(57) ABSTRACT

A system, method, and computer readable medium for affiliate redirection. There are process steps and modules for receiving a first URL request, recording request information regarding the first URL request; making the request information available to a merchant; and redirecting the URL request to a second URL having no variables, wherein the redirection indicates a permanent redirection. Additional steps include: instructing a shopper to write a cookie containing request information, sending request information directly to a merchant before the step of redirecting the URL request to a second URL having no variables, receiving a second URL request and providing content modified according to request information, providing content modified according to request information includes displaying an affiliate logo, providing an expiring cookie, and linking an affiliate ID to customization information and wherein the content is modified to display the customization information.

### BACKGROUND OF THE INVENTION

1. Field of the Invention

The present invention relates to affiliate redirection systems, specifically to systems for redirecting internet traffic.

2. Description of the Related Art

The Internet has become a powerful marketing medium for many market sectors. Accordingly, there are market pressures to establish a competitive presence on the Internet. Further, web pages are continually being created in escalating numbers.

In response, merchants are forced to seek methods of improving their marketing capabilities and have done so through associates and search engines. Associates direct traffic to a merchant site through links and references to the merchant, much like providing a referral. Search engines have been developed to allow users to find web pages related to their interests and needs according to how well they express themselves in a search query and how well the search engine is able to guess at what they want to find.

Initially, search engines would match search queries to text content of a web page. This was easily exploited by web page owners, as it was trivial and inexpensive to include a great amount of ‘invisible’ text on a web page and thereby achieve a front page ranking in a particular search request. This was also a problem because web page content could be very different from the ‘invisible’ text, thereby disappointing users.

Since then, search engines have continued to develop more sophisticated systems for suggesting web pages according to user searches. In doing so, search engines have sought to remove the potential for web page owners to disappoint users by abusing loopholes in the search ranking rules.

In one example, Google developed page ranking based on identifying the number of links pointing to a particular web page. The idea being that the more separate sites that link to a page, the more genuine interest there is likely to be in that page and therefore the more likely that a searcher would be interested in finding that page.

Additionally, as search engines are working to more effectively provide search information, merchants are seeking to more effectively drive web traffic to their sites. Traditional advertising (TV, magazines, newspaper, and the like) are generally very expensive and often have a difficult time generating web traffic because they are not directly connected to the Internet. Accordingly, merchants have worked to increase their Internet presence. Because there are limits to what an entity may accomplish alone, merchants have developed affiliate relationships with other entities whereby the affiliates may act as virtual sales people for the merchant. Typically, a merchant will pay these affiliates some type of commission on traffic, leads, or sales generated through the affiliate.

Non-limiting examples of some of the advances in the arts related to those described above include the following US patents/applications, the entire contents of which are incorporated by reference herein for their supporting teachings:

Patent Publication No. 2003/0171977 by Singh et al. discloses methods and systems for the analysis of click-stream data of online users. The analysis methods and systems allow for the creation of new offline business methods based on online consumer behavior.

U.S. Pat. No. 5,870,546 by Kirsch discloses a Web server computer system for server based controlled management over a client reference to a resource locator independently selected by a client computer system and referencing a server external Web server. The Web server system provides a client system with a predetermined URL reference to the Web server system encoded with predetermined redirection and accounting data including a reference to a second server system. On receipt by the first Web server system of the predetermined URL reference from said client system, the predetermined redirection and accounting data is decoded from the predetermined URL and processed by the Web server system to provide the client system with a redirection message including the reference to said second server system. The accounting data is processed by the Web server system and resulting data is selectively stored by the Web server system.

U.S. Pat. No. 5,751,956 by Kirsch discloses a Web server computer system for server based controlled management over a client reference to a resource locator independently selected by a client computer system and referencing a server external Web server. The Web server system provides a client system with a predetermined URL reference to the Web server system encoded with predetermined redirection and accounting data including a reference to a second server system On receipt by the first Web server system of the predetermined URL reference from the client system, the predetermined redirection and accounting data is decoded from the predetermined URL and processed by the Web server system to provide the client system with a redirection message including the reference to the second server system. The accounting data is processed by the Web server system and resulting data is selectively stored by the Web server system.

U.S. Pat. No. 6,029,141 by Bezos et al. discloses an Internet-based referral system that enables individuals and other business entities to market products, in return for a commission, that are sold from a merchant's Web site. The system includes automated registration software that runs on the merchant's Web site to allow entities to register as associates. Following registration, the associate sets up a Web site to distribute hyper-textual catalog documents that include marketing information (product reviews, recommendations, etc.) about selected products of the merchant. In association with each such product, the catalog document includes a hyper-textual “referral link” that allows a user to link to the merchant's site and purchase the product. When a customer selects a referral link, the customer's computer transmits unique IDs of the selected product and of the associate to the merchant's site, allowing the merchant to identify the product and the referring associate. If the customer subsequently purchases the product from the merchant's site, a commission is automatically credited to an account of the referring associate. The merchant site also implements an electronic shopping cart that allows the customer to select products from multiple different Web sites, and then perform a single “check out” from the merchant's site.

U.S. Pat. No. 6,466,966 by Kirsch discloses providing a message to a tracking server system in response to a client system referencing a predetermined resource locator that corresponds to a resource external to the tracking server system. The tracking server system indirectly provides for the client system to have an informational element selectable by the client system, where the informational element is graphically identified on the client system with informational content obtainable from a content server system through use of a content resource locator. The informational element includes a tracking resource locator, referencing the tracking server system, and data identifying the informational element. The selection of the informational element causes the client system to use the tracking resource locator to provide the data to the tracking server system and to use the content resource locator to obtain the informational content from the content server system.

U.S. Pat. No. 5,935,207 by Logue et al. discloses a method and apparatus for providing mirrored site administrators with the number of hits from a proxy's document cache and for dispatching document requests in a proxy to more efficiently allocate the document cache space within the proxy are provided. A proxy includes a document cache storing recently requested documents. The proxy is coupled to a client and to a remote server. The proxy maintains information regarding requests from the client that are serviced from the proxy's document cache such as the Uniform Resource Locator (URL) of the requested document and the number of cached responses. This information is provided by the proxy to a remote site administrator. In this manner, remote site administrators can more accurately track total hits.

U.S. Pat. No. 6,473,804 by Kaiser et al. discloses a system for indexical triggers in enhanced video productions by redirecting request to newly generated URI based on extracted parameter of first URI.

U.S. Pat. No. 6,917,972 by Basko et al. discloses a method, system and computer-readable medium for analyzing interaction or usage data, such as for customers. The interaction or usage data may be stored in log files and supplemented with data from other sources. Various data parsing information may be defined and used as part of the analysis, such as by using customer-specific information to identify various occurrences of interest. For example, when analyzing a customer's web site interaction data, the parser component can use data defining customer-specific categories of web pages. Such high-level types of occurrences can be specified in a variety of ways, such as by using a combination of a logical web site, one or more URIs corresponding to web pages, and/or one or more query strings. The data parsing information may also specify a mapping of actual web sites to one or more logical sites.

U.S. Pat. No. 5,712,979 by Graber et al. discloses a method and apparatus for attaching navigational history information to universal resource locator links on a web page.

The current state of the art continues to fail to provide accurate search results to searchers, fails to facilitate working with affiliates, fails to provide all the advantages of an affiliate relationship, fails to reduce negative impacts on search results from an affiliate relationship, and fails to provide solutions that are elegant, quick, inexpensive, reliable, functional, and the like.

Accordingly, there exists a need for affiliate redirection systems and methods that solve one or more of the problems herein described or that may come to the attention of one skilled in the art after becoming familiar with this specification.

### SUMMARY OF THE INVENTION

The present invention has been developed in response to the present state of the art, and in particular, in response to the problems and needs in the art that have not yet been fully solved by currently available affiliate redirection systems. Accordingly, the present invention has been developed to provide an affiliate redirection system including one or more of the features, structures, and/or modules described herein. In one embodiment there is a method of affiliate redirection. The method includes one or more of the steps of: receiving a first URL request; recording request information regarding the first URL request; making the request information available to a merchant, wherein the request information may include an affiliate ID; redirecting the URL request to a second URL through a permanent redirection, wherein the second URL has no variables; receiving a second URL request; and providing content modified according to request information.

The step of making the request information available to a merchant may include instructing a shopper to write a cookie containing request information wherein the cookie may include an expiration date and may have priority over another cookie having an earlier expiration date. The step of making the request information available to a merchant may include sending request information directly to a merchant before the step of redirecting the URL request to a second URL having no variables. The step of providing content modified according to request information may include displaying an affiliate logo. An affiliate ID may be linked to customization information and/or content may be modified to display customization information.

In another embodiment, there may be an affiliate redirection system, including one or more of the following: an affiliate module configured to channel interest to a merchant module, the affiliate module including one or more of the following: a request information module configured to store request information related to a URL request and to distribute that information to a merchant module; a redirection module configured to redirect network traffic to a merchant module; and customization information functionally linked to the request information; and a merchant module configured to display content information, including one or more of the following: a customization module configured to customize content according to customization information when the merchant module is presented with a URL request associated with request information.

A request information module may include a cookie generation module configured to cause a cookie to be written to a browser module. A cookie generation module may write a cookie having an expiration date therein.

In a still further embodiment, there may be an article of manufacture comprising a program storage medium readable by a processor and embodying one or more instructions executable by the processor to perform a method for redirecting network traffic, the method comprising one or more of the following steps: receiving a first URL request; recording request information regarding the first URL request; making the request information available to a merchant; providing customization information to a merchant module; and redirecting the URL request to a second URL having no variables.

The step of making the request information available to a merchant may include instructing a shopper to write a cookie containing request information. The step of making the request information available to a merchant may include sending request information directly to a merchant before the step of redirecting the URL request to a second URL having no variables. The redirecting step may be presented as a permanently redirected link.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not therefore to be considered to be limiting of its scope, the invention will be described and explained with additional specificity and detail through the use of the accompanying drawing(s), in which:

FIG. 1 illustrates an affiliate system according to one embodiment of the invention;

FIG. 2 is a sequence diagram showing a method of referring according to one embodiment of the invention;

FIG. 3 illustrates a protocol format according to one embodiment of the invention;

FIG. 4 is a flowchart showing a method of submitting an affiliate link according to one embodiment of the invention;

FIG. 5 is a flowchart showing a method of processing a link according to one embodiment of the invention;

FIG. 6 is a flowchart showing a method of processing a cookie according to one embodiment of the invention;

FIG. 7 is a flowchart showing a method of creating an affiliate template according to one embodiment of the invention; and

FIG. 8 is a flowchart showing a method of registering an affiliate according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment or example is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional un-recited elements or method steps. “Comprising” is to be interpreted as including the more restrictive terms “consisting of” and “consisting essentially of.”

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. Various databases used herein may include: affiliate contact information; event metadata; agreement parameters per affiliate; and/or like data useful in the operation of the present invention. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, Perl, Visual Basic, SQL Stored Procedures, AJAX, extensible markup language (XML), ASP, JSP, ColdFusion, with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

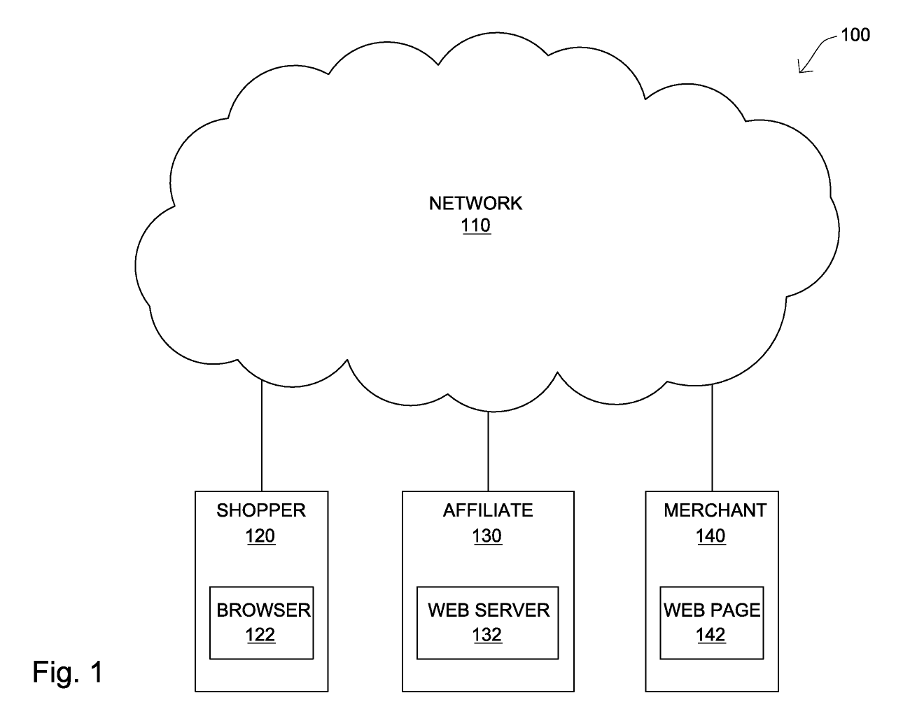

FIG. 1 illustrates an affiliate system 100 according to one embodiment of the invention. There is shown a network 110 in communication with a shopper module 120 having a browser 122, an affiliate module 130 having a web server 132, and a merchant module 140 having a web page 142. The system allows for communication between the shopper 120, affiliate 130, and merchant 140 such that the shopper may view the web page 142 through the browser 122. Accordingly, a merchant 140 may be supported in their advertising/marketing goals by the affiliate 130. A non-limiting example of an affiliate system is described in U.S. Pat. No. 6,029,141 by Bezos et al., which is incorporated herein for its supporting teachings.

While the network 110 may be defined broadly as previously described, it is envisioned that, in general/typical practice of the invention, the network is the Internet.

Just as the illustrated shopper module 120 is not limited to tools used by a purchaser of goods, the illustrated merchant module 140 is not limited to tools used by a seller of goods. Instead each may be any user of the network, wherein one desires to attract the other to view or otherwise interact with content, such as but not limited to advertising, a merchant portal, voter information, educational tools, and the like.

The illustrated browser 122 allows a user of the shopper module 120 to view content over the network 110 and in particular content available through the web page 142. Non-limiting examples of browsers include Mozilla Firefox®, Microsoft Internet Explorer®, and Netscape Navigator®.

The illustrated affiliate module 130 includes tools configured to assist an affiliate in supporting the marketing/advertising objectives of the user of the merchant module 140. The web server 132 includes hardware and/or software configured to direct the shopper module 120 to the merchant module 140. Such may include a computer having a connection to the network 110 and software for providing an initial connection with the shopper and then redirecting the shopper to the merchant. In one non-limiting example, the web server 132 includes a web page that redirects traffic to the merchant web page.

The web page 142 of the merchant module 140 provides content for the shopper that may be accessed visually or in some other way and may or may not actually be a web page. Typically, the web page 142 of the merchant module includes a web page as typically understood in the art and accordingly, for clarity in understanding the typical implementation of the invention the term “web page” has been used to identify such content of the merchant.

In operation, the affiliate module 130 attracts the shopper module 120 and redirects the shopper module 120 to the merchant module 140 thereby expanding the scope of influence of the merchant module 140.

In one non-limiting example, an affiliate promotes a store for a commission on sales generated by visitors coming from the affiliate module (a web page in this example). A cookie is set with the Affiliate's ID when a shopper comes to the merchant site from the Affiliate's site. The number of days the cookie is valid may be set by the merchant and may be any value. A cookie may be invalid after the number of days or after the shopper comes to the merchant site through another affiliate. At such time the process begins anew and a new cookie is created.

Should a merchant create an affiliate template for an affiliate, the Affiliate ID may cause such template to be used throughout a purchase process for a shopper connected to the Affiliate ID through a cookie. Where there is no special template, a default template may be used. An affiliate template may allow for alterations of the typical experience of the shopper as compared to shoppers that arrive at a web page directly. Non-limiting examples include showing an affiliate logo on the merchant web page, providing a discount, providing access to content not otherwise accessible and the like. An affiliate may upload a logo to an affiliate profile, such that when a merchant displays a website based on a referral from the affiliate and is so informed according to cookie or other information, the merchant may display the logo together with the merchant website such that the shopper has a customized experience and may more readily attribute a good experience with the merchant with the affiliate, thereby enhancing a relationship with the affiliate.

In one embodiment, affiliate configuration information is available for review and/or modification through a configuration module. A configuration module may be hosted by an affiliate, a merchant, and/or a third-party provider/facilitator. A configuration module may include information such as but not limited to information related to affiliate payout, commission amounts and percentages, cookie duration, affiliate contact information, commissions due, and the like. A configuration module may be protected by security measures configured to prevent unauthorized access thereto.

In one embodiment there is an affiliate administration module configured to manage one or more other modules including information regarding affiliates. In one example, an affiliate administration module controls one or more configuration modules as previously described. An affiliate administration module may permit modification of affiliate information, permissions, access, and the like. Affiliate profiles may be managed (added, deleted, edited) therewith. Accordingly, affiliates and merchants may easily interact in a predictable and flexible manner that promotes profitable relationships.

An affiliate administration module may also provide access to historical and/or statistical information about an affiliate and/or affiliate profile, such as but not limited to sales, conversion %, sales volume, commissions paid, commissions earned, and the like.

In another non-limiting example, the merchant 140 may include a web server 132 and such may perform one or more of the functions described herein. Accordingly, process steps may be shared between the merchant and the affiliate in ways other than those specifically described herein. One skilled in the art would recognize these variations and be able to implement them based on the disclosure herein.

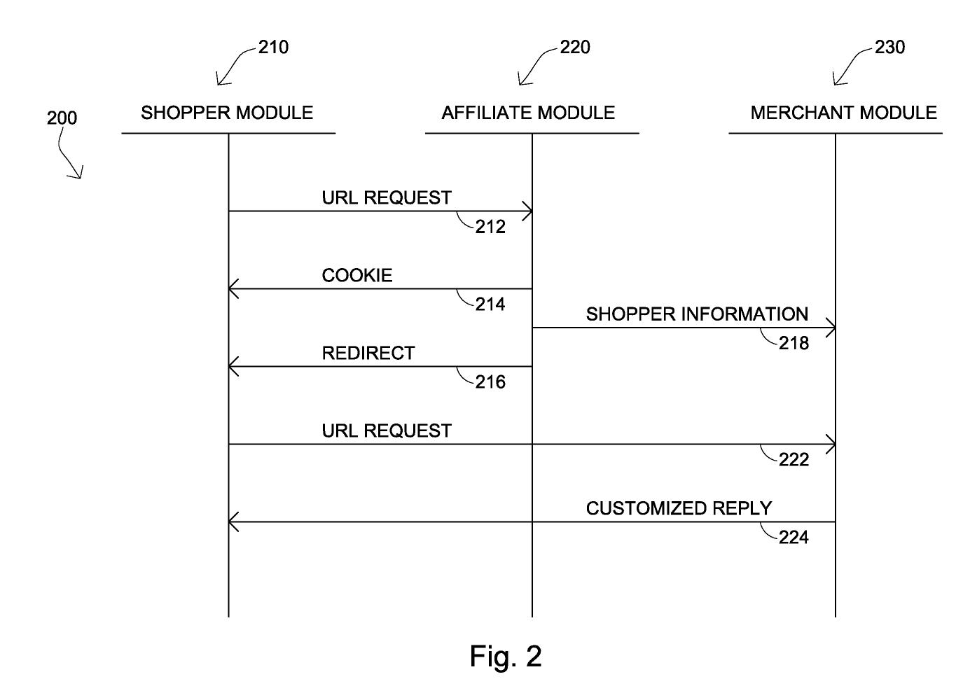

FIG. 2 is a sequence diagram showing a method of referring 200 according to one embodiment of the invention. There is shown a shopper module 210, an affiliate module 220, and a merchant module 230. Such may be as illustrated in FIG. 1.

In operation, the illustrated shopper module 210 sends a URL request 212 through a browser module to the affiliate module 220 which then generates and delivers a cookie 214 to the shopper module 210 through a cookie generation module and/or triggers delivery of shopper information to the merchant module 230. In any case, information related to the URL request 212 is preserved through a request information module in a mode such that one or more of the shopper module 210, an affiliate module 220, and a merchant module 230 may advantageously use such information. In one embodiment, the request information module includes a cookie generation module.

The affiliate module 220 redirects 216 the shopper module 210 to the merchant module 230 through a redirection module which then triggers the browser module to send a new URL request 222 to the merchant module 230 which then replies 224. The reply 224 may be a customized reply that may rely on information garnered from the cookie 214 and/or the shopper information 218 and generated by a customization module.

In one embodiment, the redirect 216 does not include any variables and is presented as a 301 redirected link (typically noted as a permanent move). It is also recommended that an .htaccess, or the like, file not be used in the redirect step. Such advantageously reduces server load. Accordingly, search engines involved in the process will appropriately credit the redirect to the merchant, thereby enhancing the circle of influence of the merchant while at the same time providing an associated increase in search engine ranking instead of diluting the ranking activities through the affiliate.

In one embodiment, a merchant module checks the referring affiliate domain and credits the affiliate accordingly.

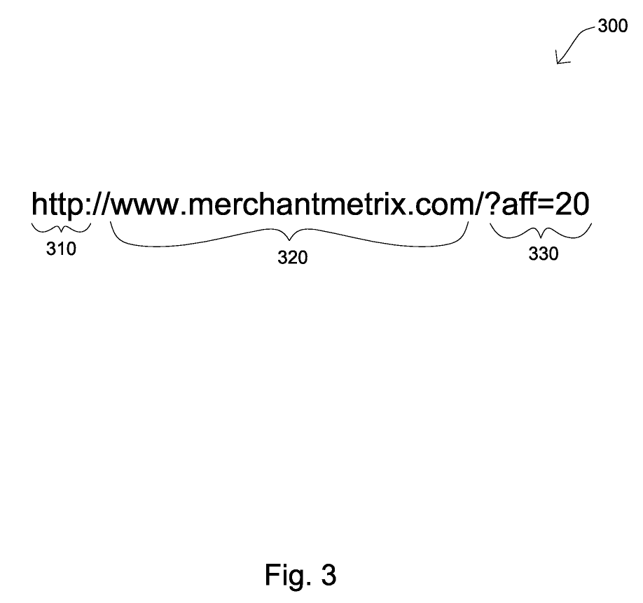

FIG. 3 illustrates a protocol format 300 according to one embodiment of the invention. There is shown a scheme name 310 followed by a host name 320 which is followed by a query string 330. Sometimes present but not shown in the present illustration are port names, path names, and file names. Ideally, the redirect 216 of FIG. 2 does not include the query string 330 or other variables that may cause search engines to improperly credit the affiliate module.

In another non-limiting example, a protocol format 300 may be expressed as follows: http://www.mercihantmetrix.com/700), wherein the “700” is query string 330 and such a URL allows links to a homepage.

In still another non-limiting example, a protocol format 300 may be expressed as follows: http://www.merchantmetrix.com/700/somepage.html, wherein the “700” is a query string 330 and such a URL allows links to a variety of home pages.

Accordingly, a query string may be expressed in a number of ways and may be used to vary implementation of embodiments of the invention.

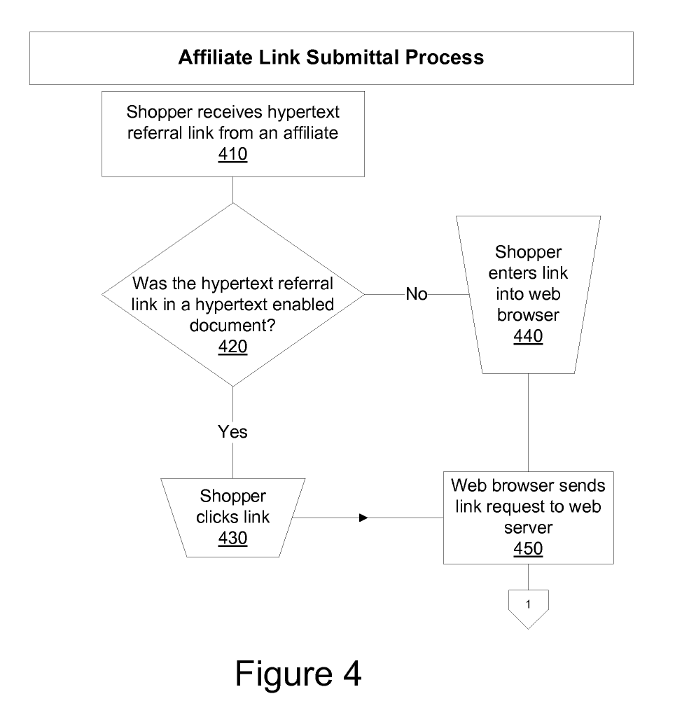

FIG. 4 is a flowchart showing a method of submitting an affiliate link according to one embodiment of the invention. Initially, a shopper receives 410 a hypertext referral link from an affiliate. Generally, the hypertext referral link includes a great deal of information useful to the affiliate. Such information is generally coded in the link and may shed light on how the shopper was contacted, what expectations the shopper may have, and the like. Accordingly, the information may be vital in establishing a continuing and/or profitable relationship with the shopper.

Where the hypertext referral link was presented in a hypertext enabled document such as but not limited to a hypertext enabled email, web page, or the like, the shopper simply clicks 430 the link or otherwise triggers activation thereof; where not, the shopper enters the link into a web browser module. The web browser then sends 450 a link request to the affiliate through its web server. Accordingly, the shopper is enabled to communicate with the affiliate through a link.

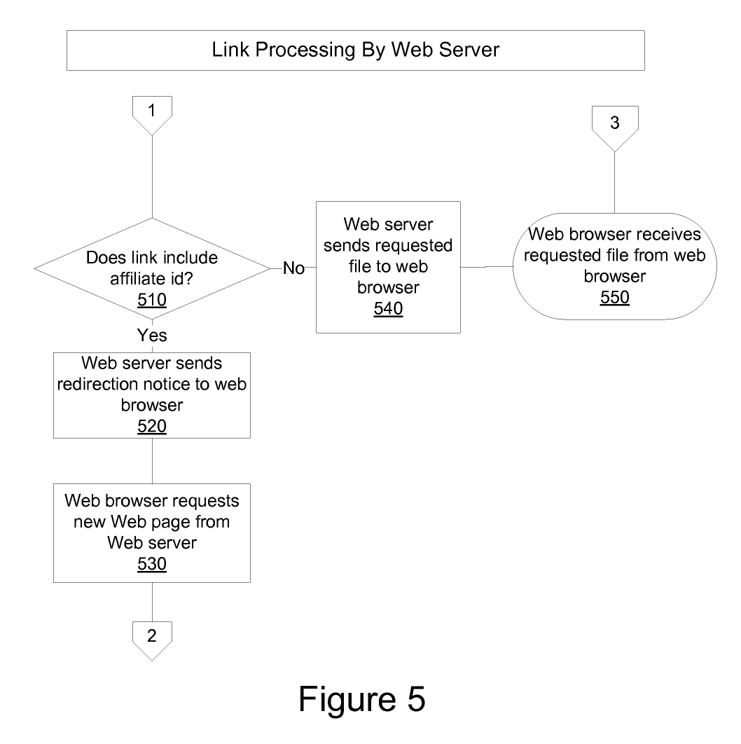

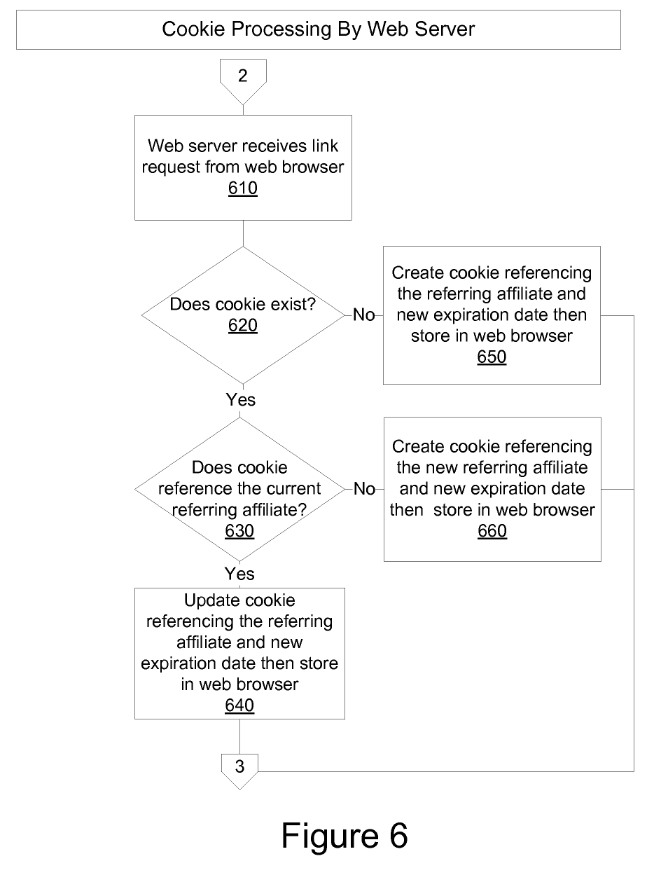

FIG. 5 is a flowchart showing a method of processing a link according to one embodiment of the invention. A link is parsed 510 to determine the existence of an affiliate ID. If the link does not include an affiliate ID, the web server sends 540 the requested file to the web browser which the web browser then receives 550. If present, the web server sends 520 a redirection notice to the web browser which then triggers the web browser to request 530 a new web page from the web server and then the process continues in FIG. 6.

FIG. 6 is a flowchart showing a method of processing a cookie according to one embodiment of the invention. A web server receives 610 a link request from a web browser which then determines if a predetermined cookie already exists. Wherein such a cookie already exists, the cookie is reviewed 630 to determine if it references the current referring affiliate. Where the cookie does reference the current referring affiliate, the cookie is updated 640 with a new expiration date. Where the cookie does not reference the current referring affiliate or where a cookie does not exist at all, a cookie is created 660 and 650 respectively referencing the current referring affiliate and an expiration date is included with the cookie. Upon completion of the steps described herein, process moves to FIG. 5 wherein the web server sends 540 the requested file to the web browser which the web browser then receives 550.

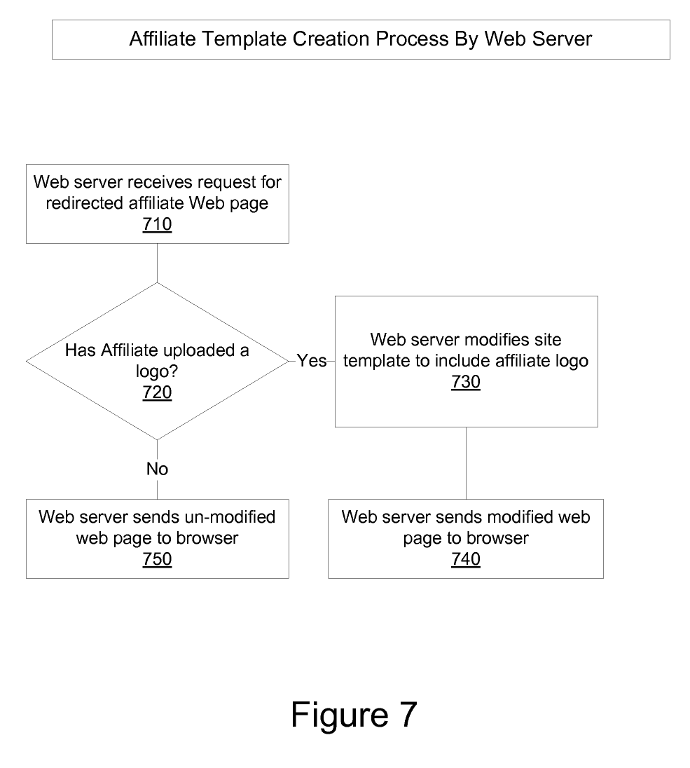

FIG. 7 is a flowchart showing a method of creating an affiliate template according to one embodiment of the invention. Wherein a web server receives 710 a request for a redirected affiliate web page, a check 720 is made against information regarding customization information, such as but not limited to if an affiliate has a logo uploaded. If not, the web server provides 750 the desired content without modification. Where customization information is available, the web server automatically modifies 730 the site template through a customization module to include such and then sends 740 the modified web page to the browser. For example, an image link may be redirected to an image of the affiliate's logo and such may be framed by the message “Brought to you by” or “Partnered with” or the like.

Non-limiting examples of customization information include: logo, tag line, special pricing, authorization and permissions, message queuing, group information, contact information, shopping instructions, and the like. Accordingly, customization information may be used to modify a shopper experience with a merchant website. It is understood that such may be utilized outside the context of a typical online retail configuration. Accordingly, the customization information may be varied and tailored to the unique experience and benefit for the shopper, affiliate, and/or merchant as desired.

In one embodiment, affiliate information or customization information (such as but not limited to template and/or logo display information) remain in place during merchant content display even upon subsequent display events. Such may be perpetual or may continue only until expiration of a cookie. Such may renew and/or change on modification, renewal, or other change to a cookie.

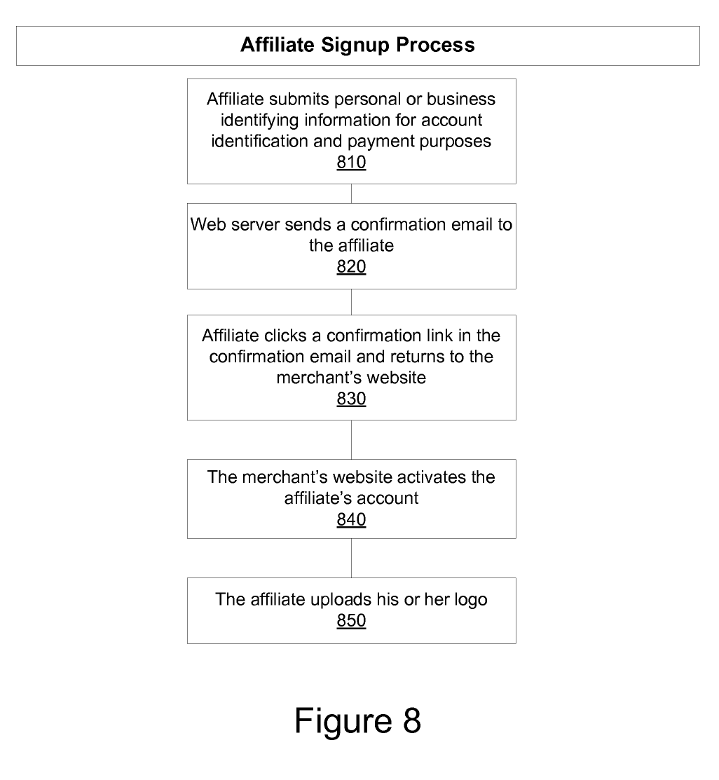

FIG. 8 is a flowchart showing a method of registering an affiliate according to one embodiment of the invention. In the illustrated embodiment, an affiliate submits 810 information relevant to carrying out one or more steps of the invention (contact information, identifying information, account information, etc.). The web server sends 820 a confirmation message to the affiliate 820 which the affiliate confirms 830. Upon receipt of confirmation the merchant's website activates 840 the affiliate's account which allows the affiliate to then upload customization information, such as but not limited to a logo image.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the figures illustrate particular orders for steps, it is envisioned that variation in the order of steps illustrated are within the scope of the invention.

Additionally, although the figures illustrate specific modes of carrying out the illustrated steps, it is envisioned that other modes may be used as one skilled in the art would be able to identify such that the step may be carried out in a variety of modes while still accomplishing the objectives of the step.

It is also envisioned that the illustrated browser may be replaced by other content viewing technology and the web server and web pages may be replaced by other content providing technology.

It is expected that there could be numerous variations of the implementation of this invention. An example is that the invention may be carried out over a telephone network.

It is expected that there could be a variety of modes in which the invention is carried out. For example, one or more of the modules may be distributed over a network, and/or may be shared across shopper, affiliate, and merchant hardware/software.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the functions, features, structures, and/or methods described herein.

What is claimed is:

1. A method of affiliate redirection, including the steps of:
receiving a first URL request;
recording request information regarding the first URL request;
making the request information available to a merchant; and
redirecting the URL request to a second URL through a permanent redirection, wherein the second URL has no variables.

2. The method of claim 1, wherein the step of making the request information available to a merchant includes instructing a shopper to write a cookie containing request information.

3. The method of claim 1, wherein the step of making the request information available to a merchant includes sending request information directly to a merchant before the step of redirecting the URL request to a second URL having no variables.

4. The method of claim 1, further comprising the steps of:
receiving a second URL request; and
providing content modified according to request information.

5. The method of claim 4, wherein the step of providing content modified according to request information includes displaying an affiliate logo.

6. The method of claim 2, further comprising the steps of:
receiving a second URL request; and
providing content modified according to request information.

7. The method of claim 2, wherein the cookie includes an expiration date.

8. The method of claim 7, further comprising the step of giving priority to a cookie having a later expiration date.

9. The method of claim 6, wherein the request information includes an affiliate ID.

10. The method of claim 9, wherein the affiliate ID is linked to customization information and wherein the content is modified to display the customization information.

11. An affiliate redirection system, including: an affiliate module configured to channel interest to a merchant module, the affiliate module including:
a request information module configured to store request information related to a URL request and to distribute that information to a merchant module;
a redirection module configured to redirect network traffic to a merchant module; and
customization information functionally linked to the request information.

12. The affiliate system of claim 11, further comprising a merchant module configured to display content information.

13. The affiliate system of claim 12, wherein the merchant module includes a customization module configured to customize content according to customization information when the merchant module is presented with a URL request associated with request information.

14. The affiliate system of claim 11, wherein the request information module includes a cookie generation module configured to cause a cookie to be written to a browser module.

15. The affiliate system of claim 14, wherein the cookie generation module writes a cookie having an expiration date therein.

16. An article of manufacture comprising a program storage medium readable by a processor and embodying one or more instructions executable by the processor to perform a method for redirecting network traffic, the method comprising:
receiving a first URL request;
recording request information regarding the first URL request;
making the request information available to a merchant; and
redirecting the URL request to a second URL having no variables.

17. The article of manufacture of claim 16, wherein the step of making the request information available to a merchant includes instructing a shopper to write a cookie containing request information.

18. The article of manufacture of claim 17, wherein the step of making the request information available to a merchant includes sending request information directly to a merchant before the step of redirecting the URL request to a second URL having no variables.

19. The article of manufacture of claim 18, wherein the method further comprises providing customization information to a merchant module.

20. The article of manufacture of claim 19, wherein the redirecting step is presented as a permanently redirected link.
